(19) United States
(12) Patent Application Publication
(10) Pub. No.: US 2008/0149851 A1
(43) Pub. Date: Jun. 26, 2008

(54) Fluorescence detecting apparatus and a fluorescence detecting method

(75) Inventors: Masao Makiuchi, Kawasaki (JP); Kazuko Matsumoto, Tokyo (JP)

Correspondence Address: KRATZ, QUINTOS & HANSON, LLP, 1420 K Street, N.W., Suite 400, WASHINGTON, DC, 20005, US

(73) Assignee: FUJITSU LIMITED, Kawasaki (JP)

(21) Appl. No.: 11/979,578

(22) Filed: Nov. 6, 2007

(30) Foreign Application Priority Data
Nov. 14, 2006 (JP) 2006-308319

(51) Int. Cl. G01N 21/64

(52) U.S. Cl. 250/461.2

(57) ABSTRACT

A fluorescence detecting apparatus is disclosed that includes a substrate on which an examining spot including a sample labeled with a fluorescent label is arranged, an excitation light irradiating optical fiber that irradiates excitation light on the examining spot, a fluorescence detecting optical fiber that detects fluorescent light generated from the examining spot, and a moving mechanism that causes relative movement of the examining spot from a position toward the excitation light irradiating optical fiber to a position toward the fluorescence detecting optical fiber.

### TECHNICAL FIELD

The present invention relates to a fluorescence detecting apparatus and a fluorescence detecting method for detecting weak fluorescent light being generated by an examined object such as a fluorescent agent labeled micro sample, a DNA micro array chip, or a protein chip that generates fluorescent light in response to excitation light.

### BACKGROUND

In detecting the fluorescence of a fluorescent micro sample, excitation light is irradiated on the sample, and the fluorescence intensity of fluorescent light generated in response to the irradiation of excitation light is detected. In such a case, the method for detecting the fluorescence may vary depending on the fluorescent agent used in the sample.

It is noted that when a fluorescent agent that generates substantially no delayed fluorescence is used in which case the generated fluorescent light disappears substantially at the same time the excitation light ceases to be irradiated, the fluorescence is detected at the time the excitation light is irradiated. In this case, the small difference between the wavelengths of the excitation light and the fluorescent light may be used to filter and separate the fluorescent light from the excitation light with an optical filter, or a configuration for blocking the excitation light from entering a fluorescence detecting region may be used to spatially separate the fluorescent light, for example.

On the other hand, when a fluorescent agent with delayed fluorescence is used in which case fluorescent light continues to be generated for some time even after excitation light irradiation is terminated, the so-called time-resolved fluorescence detection method may be used. The time-resolved fluorescence detection method involves detecting the delayed fluorescent light generated from the fluorescent label after excitation light irradiation is terminated. Exemplary labels on which the time-resolved fluorescence detection method may be used include labels containing rare earth elements such as europium (Eu) or terbium (Tb). FIG. 1A is a graph illustrating characteristics of a label that generates delayed fluorescence. For example, DTBTA-Eu3+, which contains europium, has a fluorescence spectrum with a maximum wavelength that is greater than or equal to 450 nm, and such a label continues to generate fluorescent light for about one to several milliseconds after irradiation of an excitation light pulse is terminated.

As can be appreciated, the difference between the above fluorescence detecting methods lies in whether detection is performed at the same time as the excitation light irradiation or after the excitation light irradiation.

FIG. 1B is a graph illustrating the principles of the time-resolved fluorescence detection method. In a case where a label is used that continues to generate fluorescent light (delayed fluorescence) for about one millisecond after excitation pulse irradiation is terminated, if the fluorescence is detected during the excitation pulse irradiation, background fluorescent light as represented by dotted lines in FIG. 1B may be detected as well the fluorescent light generated by the label so that detection accuracy may be degraded. It is noted that the background fluorescent light corresponds to a fluorescent light component that is emitted from a portion other than the label but has the same wavelength as the fluorescent light generated by the label.

In view of such a problem, a detection delay time Td at which the background fluorescent light completely disappears is determined (e.g., Td=0.12 msec), and fluorescence detection is performed from such a detection delay time Td in order to detect only the fluorescent light generated from the label. Also, in this case, the fluorescence detection time period Tgw is set so that the fluorescence detection is performed until a short time before the next laser pulse (excitation light pulse) is irradiated. In this way, accurate measurement with a good S/N ratio may be obtained.

It is noted that a sample may contain a label so that it may be analyzed based on its fluorescence detection result, the sample may be labeled with a fluorescent agent that generates substantially no delayed fluorescence or a fluorescent agent that generates substantial delayed fluorescence. Thus, it is rather troublesome to use a different fluorescence detecting apparatus depending on the type of fluorescent agent being used as the label in the sample to be examined, for example.

It is noted that exemplary fluorescence detecting apparatuses configured to perform time-resolved fluorescence detection are disclosed in U.S. Pat. No. 6,563,584 and Japanese Laid-Open Patent Publication No. 2002-71565, for example. The former discloses a time-resolved fluorescence detecting apparatus that uses a rotating disk and the latter discloses a flow-type time-resolved fluorescence detecting apparatus.

FIGS. 2A and 2B are diagrams illustrating an exemplary configuration of a disk-type time-resolved fluorescence detecting apparatus disclosed in U.S. Pat. No. 6,563,584. In these drawings, a biochip 110 having sample spots 111 arranged in radial directions is mounted on a rotating disk 112. A label that generates delayed fluorescence is placed in each sample spot 111. The illustrated apparatus includes a CW laser 120, and an excitation light irradiating optical system 130 and a fluorescent light detecting optical system 140 that are arranged to be independent of each other. As is shown in FIG. 2A, at time t1, a beam excited by the CW laser 120 is irradiated on a sample spot 111a by the excitation light irradiating optical system 130. The disk 112 rotates in the direction indicate by arrow R, and at time t2, the delayed fluorescence generated from the sample spot 111a is detected by the fluorescent light detecting optical system 140.

According to the above configuration, the distance between the laser irradiating position and the fluorescence detecting position is rather long so that the delayed fluorescence may not be detected unless the disk is rotated at a significantly high speed. Also, the illustrated apparatus cannot be used for detecting the fluorescence of labels that generate no delayed fluorescent light.

FIG. 3 is a diagram illustrating a configuration of a flow-type time-resolved fluorescence detecting apparatus as is disclosed in Japanese Laid-Open Patent Publication No. 2002-71565. In this example, a fluid sample 155 is excited at an upstream position and the delayed fluorescent light generated by this excitation is detected at a downstream position. It is noted that this apparatus is also incapable of detecting the fluorescence of a label that does not generate delayed fluorescent light.

On the other hand, U.S. Pat. No. 6,504,167 discloses a fluorescent image reading apparatus as is illustrated in FIGS. 4A and 4B that may be used for detecting the fluorescence of labels that generate delayed fluorescent light as well as labels that do not generate delayed fluorescent light.

According to this example, in time-resolved detection mode as is shown in FIG. 4A, the angle of a mirror 181 is adjusted by an angle adjusting mechanism 183 so that laser light 200 incident to an optical head 180 may be guided to an excitation point 235 on an image carrier 222 via a converging lens 186. A fluorescent image with delayed fluorescence is read at a detection point 236 that is spaced apart from the excitation point 235 by a distance L4. Specifically, fluorescent light emitted from a fluorescent color at the detection point 236 is converged by the converging lens 187, reflected by a mirror 185 having a hole 184, and guided toward an optical system (not shown) at the downstream side.

In simultaneous detection mode as is shown in FIG. 4B, an image formed on a fluorescent layer that generates no delayed fluorescent light is read. In this case, the mirror 181 is cleared from the optical path, and the incident light 200 is reflected by a mirror 182, passes through the hole 184 of the mirror 185, and excites the fluorescent material arranged at excitation point 235 with the converging lens 187. In this example, fluorescent light is emitted at the same time as the excitation. The emitted fluorescent light 225 is arranged into parallel light by the converging lens 187 and is reflected by the mirror 185 to guided toward the optical system (not shown) at the downstream side.

According to the above disclosure, the mirror 181 can only be in one of two positions, namely, a lowered position and a raised position, so that the detection delay time Td shown in FIG. 1B may not be adjusted by successively changing its value from zero to find an optimal value for detecting the fluorescence of a given label, for example.

Also, according to the above disclosure, an optical system is used that includes a laser, an objective lens (converging lens), a reflection mirror, and a mobile mirror, for example, so that the apparatus may be large and complicated. Thus, it may be difficult to set the distance L4 between the excitation point 235 and the detection point 236 to approximately 2 mm, for example. Additionally, the disclosed apparatus may be vulnerable to vibration. Further, the fluorescent light generated from a sample spot does not have monochromaticity and coherency so that when such fluorescent light is detected using the converging lens 187 and the reflection mirror 185, the incidence efficiency of the fluorescent light with respect to the detection means may be decreased and the measurement may be difficult.

### SUMMARY

In one embodiment of the present invention, optical fibers are used for excitation light irradiation and fluorescence detection, and an examining spot including a fluorescence labeled sample is arrange to move relative to the positions of the excitation light irradiating optical fiber and the fluorescence detecting optical fiber so that efficient fluoresce detection may be enabled using a simple structure.

### BRIEF DESCRIPTION OF THE DRAWINGS

FIGS. 1A and 1B are diagrams illustrating the time-resolved fluorescence detecting method;

FIGS. 2A and 2B are diagrams showing an exemplary configuration of a disk type time-resolved fluorescence detecting apparatus according to the prior art;

FIG. 3 is a diagram showing an exemplary configuration of a flow type time-resolved fluorescence detecting apparatus according to the prior art;

FIGS. 4A and 4B are diagrams showing an exemplary configuration of an image reading apparatus according to the prior art that is adapted to perform both time-resolved fluorescence detection and simultaneous fluorescence detection;

FIG. 5 is a diagram showing a basic configuration of a fluorescence detecting apparatus according to a first embodiment of the present invention;

FIG. 6 is a diagram showing an exemplary overall configuration of a fluorescence detecting apparatus that uses the basic configuration shown in FIG. 5;

FIG. 7 is a graph illustrating a sample moving speed and a sample moving time in relation to the rotation number of a rotating plate;

FIG. 8 is a graph illustrating a relationship between the sample moving time and the distance between an excitation light irradiating optical fiber and a fluorescence detecting optical fiber;

FIG. 9 is a diagram showing a basic configuration of a fluorescence detecting apparatus according to a second embodiment of the present invention;

FIG. 10 is a diagram showing a basic configuration of a fluorescence detecting apparatus according to a third embodiment of the present invention;

FIG. 11 is a diagram showing a basic configuration of a fluorescence detecting apparatus according to a fourth embodiment of the present invention;

FIG. 12 is a diagram showing a basic configuration of a fluorescence detecting apparatus according to a fifth embodiment of the present invention;

FIG. 13 is a diagram showing a modification example of the fifth embodiment;

FIG. 14 is a diagram showing an exemplary overall configuration of a fluorescence detecting apparatus that uses the basic configuration shown in FIG. 12;

FIG. 15 is a diagram showing an exemplary arrangement of examining spots in the case of using a rotating stage;

FIG. 16 is a diagram showing another exemplary arrangement of examining spots in the case of using an oscillating stage; and

FIGS. 17A-17C are diagrams showing exemplary edge configurations of the optical fibers.

### DETAILED DESCRIPTION OF THE EMBODIMENTS

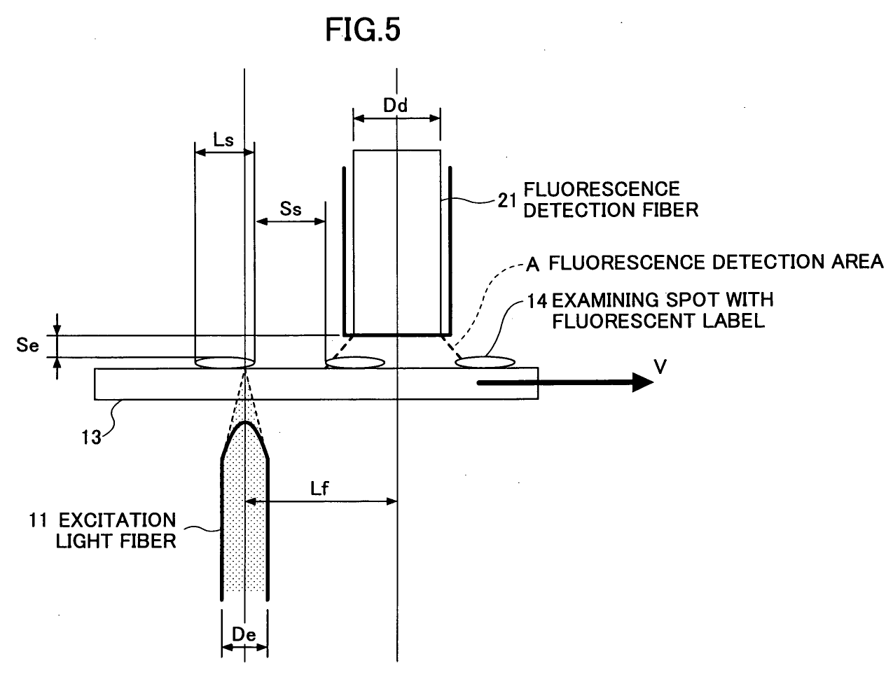

FIG. 5 is a diagram showing a basic configuration of a fluorescence detecting apparatus according to a first embodiment of the present invention. The illustrated fluorescence detecting apparatus includes a substrate 13 having examining spots 14 where fluorescent agent labeled samples are arranged, an excitation light irradiating optical fiber 11 (simply referred to as excitation optical fiber 11 hereinafter) for irradiating excitation light on the examining spots 14, and a fluorescence detecting optical fiber 21 (simply referred to as fluorescence detection fiber 21 hereinafter) for detecting the fluorescent light emitted from the examining spots 14 in response to the irradiation of the excitation light. The examining spots 14 are arranged to be moved (displaced) relative to the positions of the excitation light fiber 11 and the fluorescence detection fiber 21.

In the example of FIG. 5, the substrate 13 having the examining spots 14 arranged thereon is transparent and moves at speed V in the direction of the indicated arrow. Also, the excitation light fiber 11 and the fluorescence detection fiber 21 are arranged on opposite sides of the substrate 13.

When a sample arranged on an examining spot 14 subject to detection is labeled with a fluorescent agent that generates delayed fluorescent light, the excitation light fiber 11 and the fluorescence detection fiber 21 are positioned away from each other by a predetermined distance Lf with respect to the relative movement direction of the examining spot 14. The distance Lf is arranged such that the background fluorescent light may cease to be generated and only the fluorescent light from the label is generated by the time the examining spot 14 reaches a position right below the fluorescence detection fiber 21 after being excited by the excitation fiber 11 and moved (displaced) toward the fluorescent detection fiber 21.

On the other hand, when the sample arranged on the examining spot 14 subject to detection is labeled with a fluorescent agent with little or substantially no delayed fluorescence, the excitation light fiber 11 and the fluorescence detection fiber 21 are arranged to be positioned face to face with each other. In other words, the distance Lf between the excitation light fiber 11 and the fluorescence detection fiber 21 is set to Lf=0. As can be appreciated from the above descriptions, by adjusting the distance between the optical fibers 11 and 21, both time-resolved fluorescence detection and simultaneous fluorescence detection may be performed with a simple configuration.

It is noted that in the present example, the distance Lf between the optical fibers 11 and 21 corresponds to the distance between the centers of the excitation light fiber 11 and the fluorescence detection fiber 21. Also, the excitation light fiber 11 has a diameter De, the fluorescence detection fiber 21 has a core diameter Dd, the examining spots 14 arranged on the substrate 13 each have diameters Ls, the examining spots 14 are spaced apart from each other at intervals Ss, the fluorescence detection fiber 12 and the examining spots 14 are set apart by a distance Se, and the examining spots 14 are arranged to move relative to the positions of the excitation light fiber 11 and the fluorescence detection fiber 21 at a relative moving speed V.

In the case where the substrate 13 with the examining spots 14 is arranged to move as in the illustrated example of FIG. 5, the relative moving speed V may correspond to the moving speed of the substrate 13. In other examples, the excitation light fiber 11 and the fluorescence detection fiber 21 as a combined unit may be arranged to move instead of or simultaneously with the substrate 13.

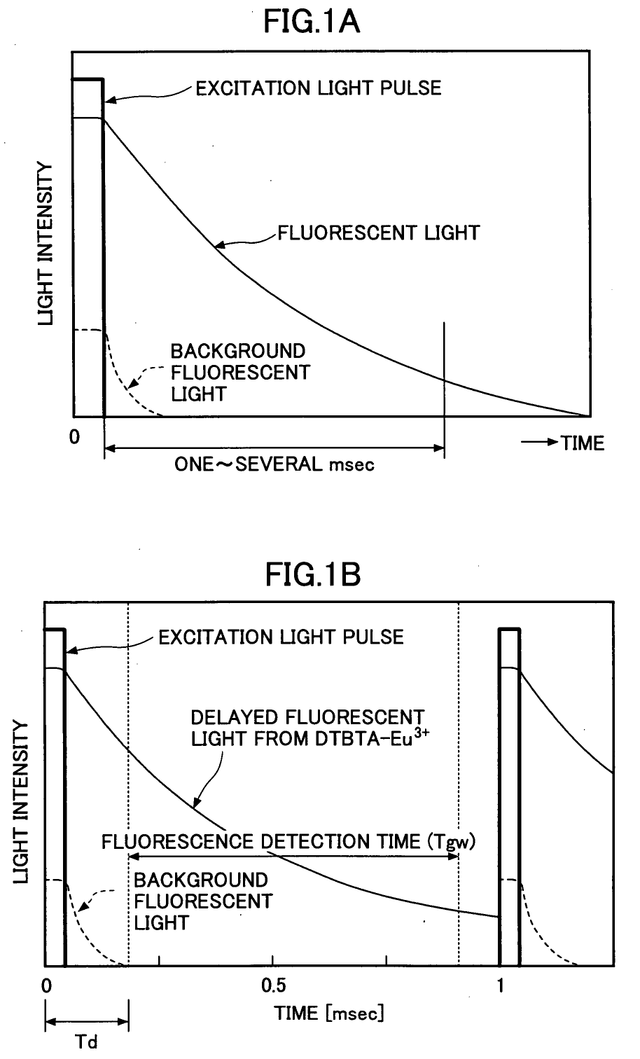

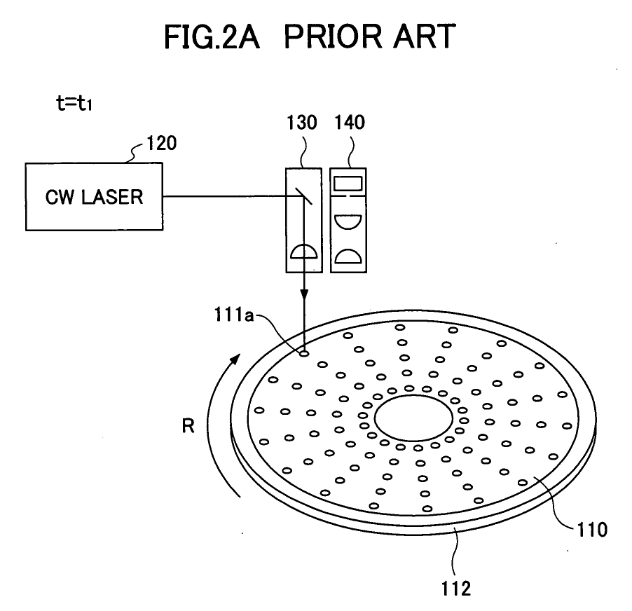

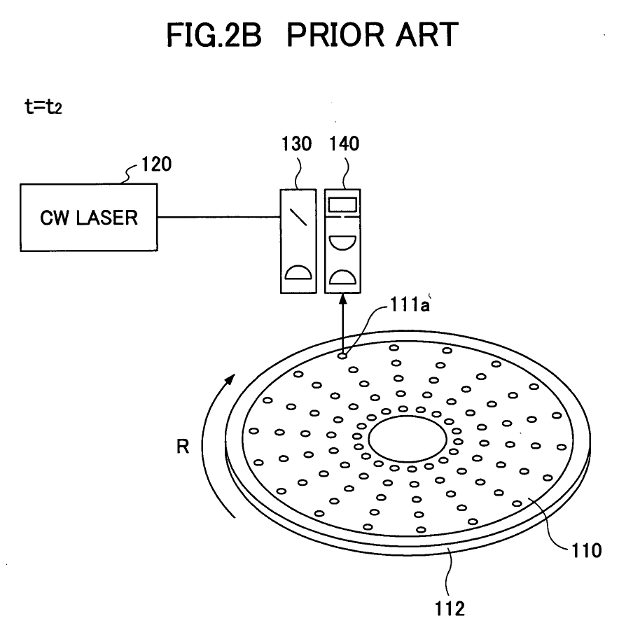

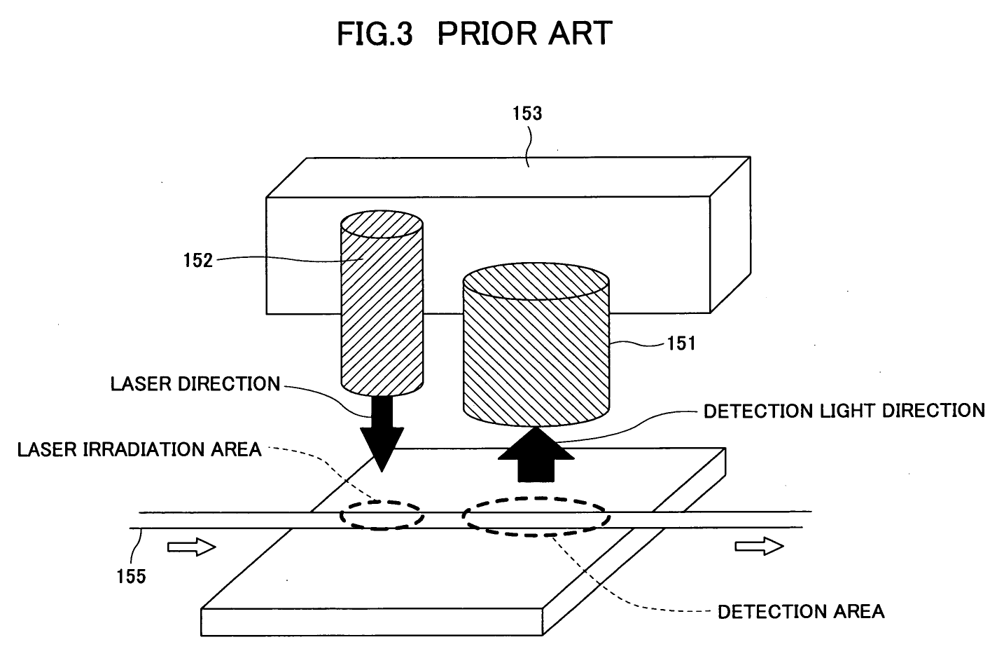

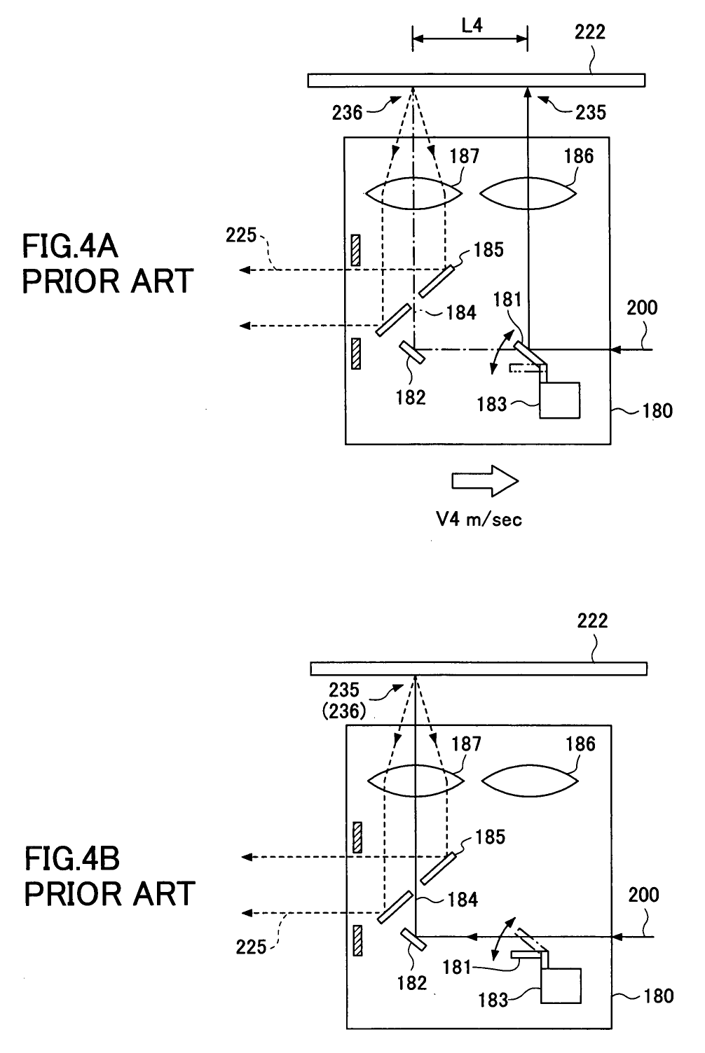

The diameter De of the excitation light fiber 11 and the diameter Dd of the fluorescence detection fiber 21 may each be set to suitable values within a range of 100-1000 micrometers. The distance Lf between the optical fibers 11 and 21 may be selectively set to a value within a range of zero to several dozen millimeters. In turn, the detection delay time Td (see FIG. 1B) may be successively changed from zero to a predetermined value. In this way, the delay detection start time may be optimized through simple procedures in the case of detecting delayed fluorescence.

It is noted that the distance Lf between the optical fibers 11 and 21 may be represented by the following formula:

Lf=V*Td

where V denotes the relative moving speed of the substrate 13 with respect to the optical fibers 11 and 21, and Td denotes the detection delay time (i.e., the difference between the excitation light irradiation start time and the fluorescence detection start time).

In one embodiment, the edge of the excitation light fiber 11 may be processed to have a lens function so that the excitation light irradiation area size may be controlled to be approximately several dozen times the wavelength of the excitation light. In this way, the resolution may be adequately increased.

The core diameter Dd and the edge surface configuration of the fluorescence detecting fiber 21 may be designed so that only light from a predetermined area may be incident thereto. By using an optical fiber for fluorescence detection, the distance Se between the fluorescence detecting fiber 21 and the examining spot 14 may be adequately short so that most of the fluorescent light generated from the examining spot 14 may be incident to the fluorescence detecting fiber 21. It is noted that the distance Se may be within a range of 50 μm to 1 mm. For example, when the distance Se is set to approximately 100 μm, the fluorescence detection area may be confined to detection area A as is shown in FIG. 5 so that fluorescent light may not be detected unless the examining spot 14 is positioned within the fluorescence detection area A. Accordingly, even when a next examining spot 14 is excited by the excitation light fiber 11 during fluorescence detection of a currently examining spot 14, only fluorescent light generated from the current examining spot that is positioned directly below the fluorescence detection fiber 21 may be subject to detection.

The size of the fluorescence detection area A is arranged so that only one of the examining spots 14 may be positioned within this area at a given time. In other words, the core diameter Dd and the incidence surface configuration of the fluorescence detection fiber 21 are adjusted so that more than one examining spot 14 may not be positioned within this area A at the same time.

In one embodiment, the excitation light power, the positions of the excitation light fiber 11 and the fluorescence detection fiber 21, and the number of optical fibers used may be selectively adjusted to improve detection sensitivity.

It is noted that the configuration of FIG. 5 may be readily adapted to detect the fluorescence of a sample labeled with a fluorescent label that generates little or substantially no delayed fluorescent light by adjusting the distance Lf between the optical fibers 11 and 21.

Specifically, in the case where a label with little or substantially no delayed fluorescence is used in the sample arranged on the examining spot 14, the distance Lf may be arranged close to zero so that the excitation light fiber 11 and the fluorescence detection fiber 21 may be positioned at substantially the same point on opposite sides of the substrate 13.

As can be appreciated from the above descriptions, by using a basic configuration that includes optical fibers capable of guiding light rather than using a configuration that spatially propagates light using a lens system, a simple apparatus that is capable of performing both time-resolved fluorescence detection and simultaneous detection may be realized.

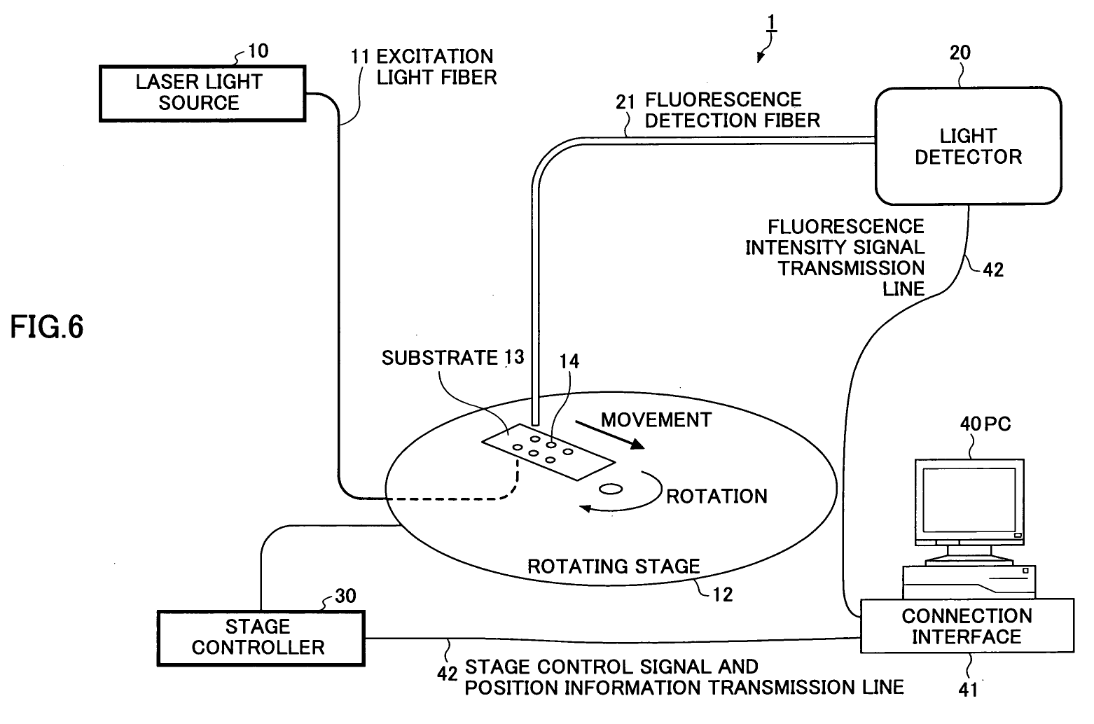

FIG. 6 is a diagram showing an overall configuration of a fluorescence detecting apparatus that uses the basic configuration shown in FIG. 5.

The illustrated fluorescence detecting apparatus 1 includes a continuous wave (CW) laser light source 10 as the excitation light source, a UV optical fiber as the excitation light fiber 11 that is connected to the CW laser light source 10, a light detector 20, a fluorescence detection fiber 21 that is connected to the light detector 20, a rotating stage 12 that supports the substrate 13 with examining spots 14. In one example, the light detector 20 may be a photomultiplier tube (PMT). The detection results obtained by the light detector 20 (fluorescence intensity information) are input to a PC 40 via a transmission line 42 to be analyzed and processed. It is noted that transmission of the fluorescence intensity information (signal) does not necessarily have to be performed using a cable and may also be realized through wireless communication.

The fluorescence detection apparatus 1 also includes a stage controller 30 that controls movement of the rotating stage 12. The stage controller 30 is connected to the PC 40 via the transmission line 42 and a connection interface 41 so that stage control signals and position information may be input from the PC 40 to the stage controller 30.

In the illustrated example of FIG. 6, the excitation light fiber 11 and the fluorescence detection fiber 21 are positioned on opposite sides of the rotating stage 12. In the case of examining a sample with a label that generates delayed fluorescent light, the fluorescence detection fiber 21 is offset from the position of the excitation light fiber 11 by a predetermined distance Lf to enable time-resolved fluorescence detection. In the case of examining a sample with a label that generates little or substantially no delayed fluorescent light, the fluorescence detection fiber 21 is moved to the position of the excitation light fiber 11. In one preferred embodiment, the offsetting distance of the fluorescence detection fiber 21, that is, the distance Lf between the optical fibers 11 and 21, may be adjusted according to the duration of the delayed fluorescent light generation time, which may vary according to the type of fluorescent label used. In other embodiments, the rotating speed of the rotating stage 12 may be adjusted in addition to or instead of adjusting the distance Lf.

According to the example of FIG. 6, the rotating stage 12 rotates so that the examining spots 14 arranged on the substrate 13 may move in a circumferential direction relative to the positions of the excitation light fiber 11 and the fluorescence detection fiber/21. Also, in the present example, the rotating stage moves in a parallel direction so that fluorescence detection may be performed on an examining spot 14 that is next in line after fluorescence detection of a current examining spot 14 is performed. In alternative examples, the excitation light fiber 11 and the fluorescence detection fiber 21 as a combined unit may be moved toward the center of the rotating stage instead of or in addition to moving the rotating stage in a parallel direction.

The examining spots 14 may be arranged within an area located 3-8 cm away from the center of the rotating stage, for example. It is noted that although only one substrate 13 is placed on the rotating stage 12 in the illustrated example of FIG. 6, the rotating stage may be adapted to have plural substrates 13 arranged thereon in radial directions, for example. Also, the spot diameter of the examining spots 14 may be set to 50 μm, for example.

In the process of examining a given sample, position information of an examining spot 14 that has reached the excitation irradiation position of the excitation light fiber 11 and information on the fluorescence intensity detected from this examining spot 14 may be associated with each other so that the PC 40 may reconstruct a fluorescent image based on such information, for example.

In the detection apparatus of the present example, detection operations may be easily switched between time-resolved fluorescence detection mode and simultaneous fluoresce detection mode by merely adjusting the relative positioning of the excitation light fiber 11 and the fluorescence detection fiber 21 rather than using a mechanical structure such as a shutter to block or pass excitation light, for example.

Also, in the present example, light emitted from the laser light source 10 may be a continuous wave (CW) laser and does not have to be a pulsed laser. The light detector 20 does not have to include a detection time control mechanism/function, and may be configured to continually detect fluorescence and transmit the detection result as an electrical signal to the PC 40. However, it is noted that a synchronization signal for associating position information of an examining spot with its corresponding fluorescence intensity information has to be generated from either the rotating stage 12 side or the detector 20 side. Also, since the PC 40 is configured to process a digital signal, A/D conversion may be performed at the connection interface 41 of the PC 40.

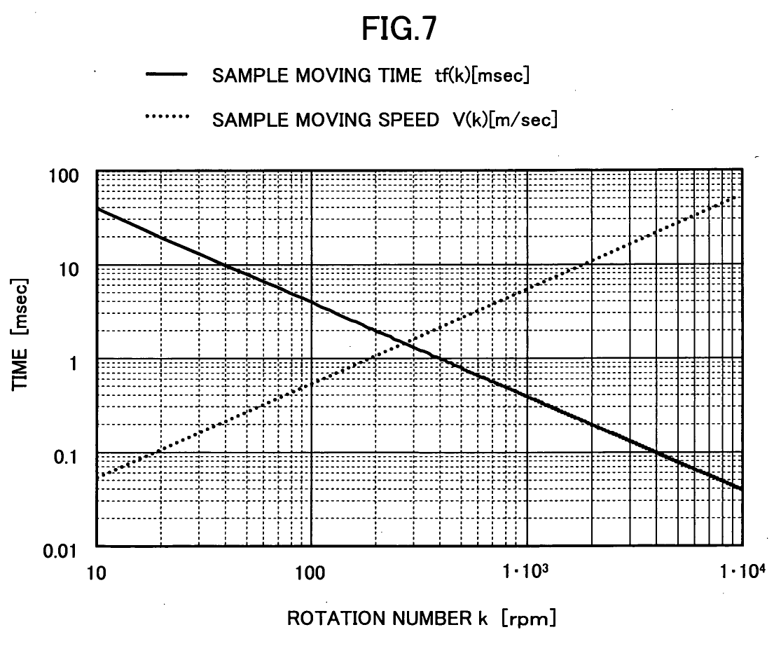

FIG. 7 is a graph showing the sample moving time tf(k) [msec] for an examining spot 14 (sample) arranged at a 5-cm-radius position from the center of the rotating stage 12 to move a distance of Lf=2 mm and the sample moving speed V (k) [m/sec] in relation to the rotation number k (rpm) of the rotating stage 12.

According to FIG. 7, if the detection delay time Td=0.1 msec, then the sample moving time tf(k)=0.1 msec and the rotation number k of the rotating stage 12 is 4000 rotations per minute (rpm). In this case, the relative moving speed V(k) of the examining spot 14 (sample) is 20 m/sec. If the core diameter Dd of the fluorescence detection fiber 21 is arranged to be 50 μm, the time width of the detected fluorescent light pulse may be approximately 2.5 μsec.

Provided that ‘a’ [m] denotes the rotation radius (e.g., a=0.05 [m] in the illustrated example of FIG. 7), and ‘T(k)’ [sec] denotes the rotation period, T(k) and V(k) may be expressed by the following formulae:

T(k)=60/k

V(k)=2πa/T(k)

Also, the sample moving time tf(k) for the examining spot (sample) 14 to move the distance Lf may be expressed by the following formula:

tf(k)=Lf/V(k)

It is noted that in the example of FIG. 7 the distance Lf [m] between the optical fibers is set to 0.002.

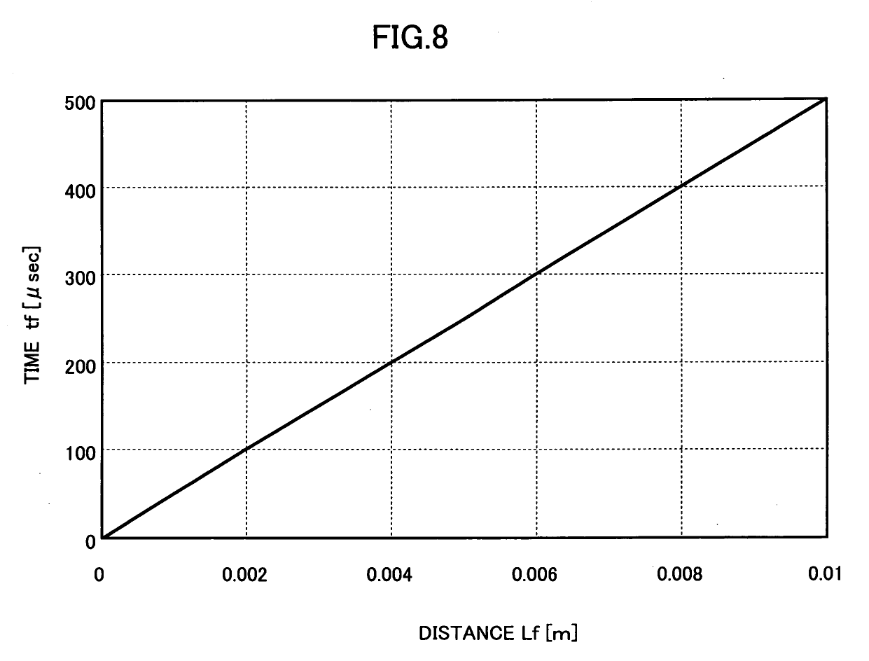

FIG. 8 is a graph showing a relationship between the distance Lf [m] and the moving time tf [μsec] in a case where the relative moving speed V(k) of the examining spot 14 is 20 m/sec.

The distance Lf [m] between the optical fibers may be adjusted to a suitable value between 0 to 10 mm, and in turn, the sample moving time tf corresponding to the detection delay time Td may be adjusted to a value between 0 to approximately 500 μsec, for example. The fluorescence detection time Tgw (see FIG. 1B) may be determined by the core diameter Dd and the edge surface configuration of the fluorescence detection fiber 21, and the relative moving speed V(k) of the examining spot 14.

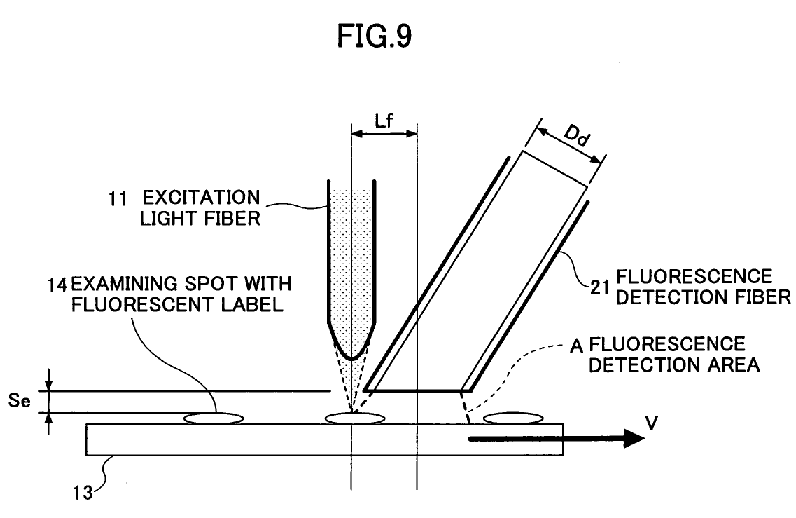

FIG. 9 is a diagram showing a basic configuration of a fluorescence detecting apparatus according to a second embodiment of the present invention. The illustrated configuration may be suitably used in a case where the substrate 13 does not have permeability with respect to the excitation light.

In the illustrated example of FIG. 9, the edge of the fluorescence detection fiber 21 is arranged to be diagonal, and the fluorescence detection area A of the fluorescence detection fiber 21 covers the excitation light irradiation spot of the excitation light fiber 11. In this way, fluorescent light may be detected immediately after irradiating excitation light on the examining spot 14 (i.e., the detection delay time Td may be set substantially to zero) to thereby enable fluorescence detection of a sample with a label that generates substantially no delayed fluorescent light as well as a sample with a label that generates delayed fluorescent light with out changing the distance Lf between the optical fibers 11 and 21. It is noted that the distance Lf between the optical fibers 11 and 21 may be increased to secure a predetermined detection delay time Td so that detection operations may suitably adapted for detecting a label with delayed fluorescence. However, a label with delayed fluorescence may also be detected using the configuration shown in FIG. 9 where the excitation light irradiation spot is located within the fluorescence detection area A although background fluorescent light may be detected in this case due to the fact that fluorescence detection is performed right after excitation light irradiation. In other words, the configuration of FIG. 9 may be used for detecting both a regular fluorescent label (with no delayed fluorescence) and a fluorescent label with delayed fluorescence without adjusting the positioning of the excitation light fiber 11 and the fluorescence detection fiber 21.

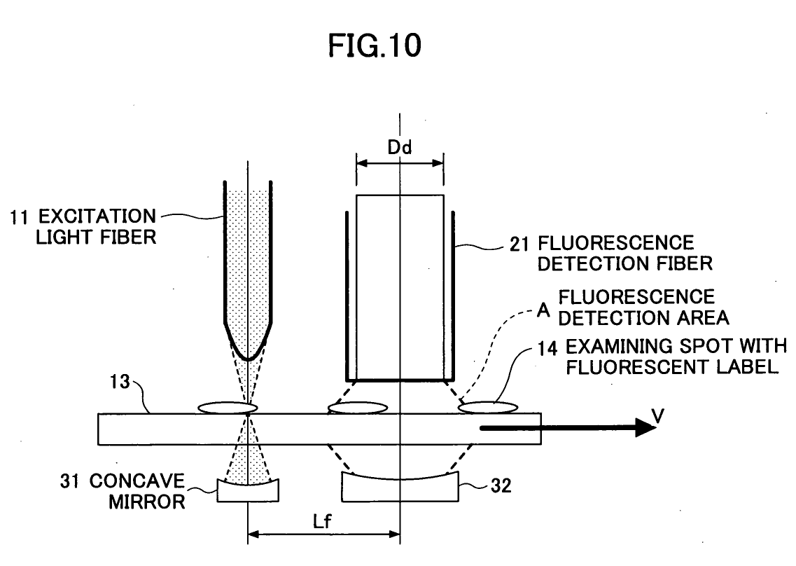

FIG. 10 is a diagram showing a basic configuration of a fluorescence detecting apparatus according to a third embodiment of the present invention. In this illustrated example, the excitation light fiber 11 and the fluorescence detection fiber 21 are arranged on the same side of a substrate 13 corresponding to a light transmitting substrate, and concave mirrors 31 and 32 that are configured to reflect light transmitted through the substrate 13 back to the excitation light fiber 11 and the fluorescence detection fiber 21, respectively, are arranged on the opposite side of the substrate 13. By reflecting and redirecting the transmitted light back to the excitation irradiation spot and the fluorescence detection area A, the excitation light intensity and the fluorescence detection efficiency may be improved.

In a modified example of the present configuration, only one of the concave mirrors 31 or 32 may be used depending on the intensity of the laser light source 10 being used.

According to the present embodiment, the detection delay time cannot be Td=0 msec even when the excitation light fiber 11 and the fluorescence detection fiber 21 are positioned as close as possible to each other. For example, if an optical fiber with a 125-μm-radius is used as the excitation light fiber 11 and the fluorescence detection fiber 21, then Lf=250 μm. In this case, if the relative moving speed V of the examining spot 14 is set to V=20 m/sec, the detection delay time Td=12.5 μsec at minimum; that is, the detection delay time Td cannot be set to zero. However, it is noted that even conventional labels with little or substantially no delayed fluorescence do have some delayed fluorescence characteristics of around several dozen microseconds. Thus, the detection delay time Td does not necessarily have to be set to exactly zero. In other words, by arranging the optical fiber diameter to be adequately small, fluorescence detection of conventional fluorescent colors such as Cy3 and Cy5 may be possible.

As can be appreciated from the above descriptions, the distance Lf between the optical fibers may be shorter when concave mirrors are not used. Specifically, when the excitation light fiber 11 and the fluorescence detection fiber 21 are arranged on opposite sides of the substrate 13 as is shown in FIG. 5, the distance Lf may be set to Lf=0. Also, even when the excitation light fiber 11 and the fluorescence detection fiber 21 are arranged on the same side of the substrate 13 the distance Lf may be set substantially close to zero by arranging the edge of the fluorescence detection fiber 21 to be diagonal as is shown in FIG. 9 (i.e., in this case, the excitation light fiber 11 and the fluorescence detection fiber 21 may be arranged very close to each other). In the case of examining a sample with a label that generates substantially no delayed fluorescent light, simultaneous fluorescence detection may be performed by arranging the distance Lf to satisfy the following condition, provided that R1 denotes the radius of the excitation light fiber 11 and R2 denotes the radius of the fluorescence detection fiber 21.

0≦Lf≦R1+R2

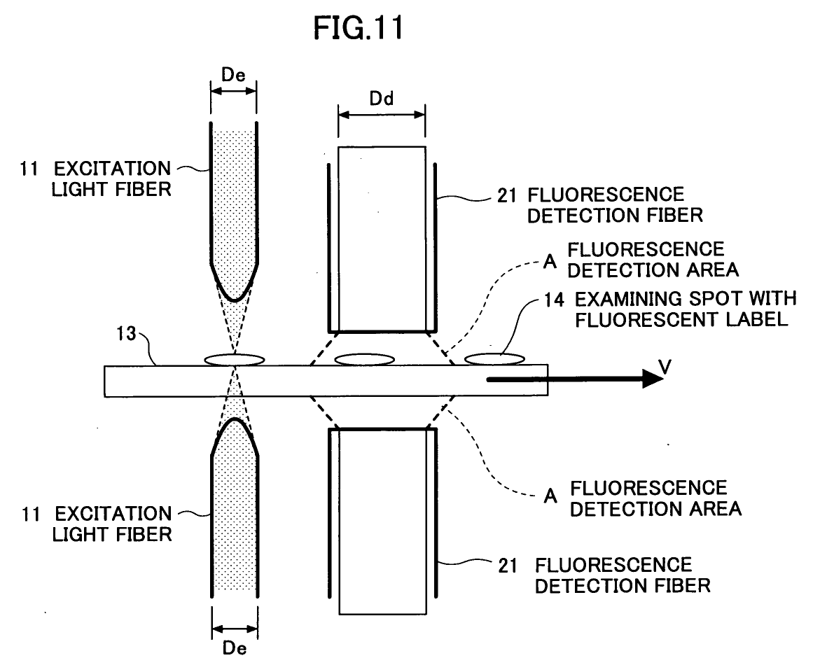

FIG. 11 is a diagram showing a basic configuration of a fluorescence detection apparatus according to a fourth embodiment of the present invention. In this embodiment, a set of the excitation light fiber 11 and the fluorescence detection fiber 21 are arranged on each side of the substrate 13. In this case, two excitation light sources 10 (see FIG. 6) are used. Also, two detectors 20 may be used, or the fluorescent light generated from the two sides of the substrate 13 may be combined to be detected by one detector 20, for example.

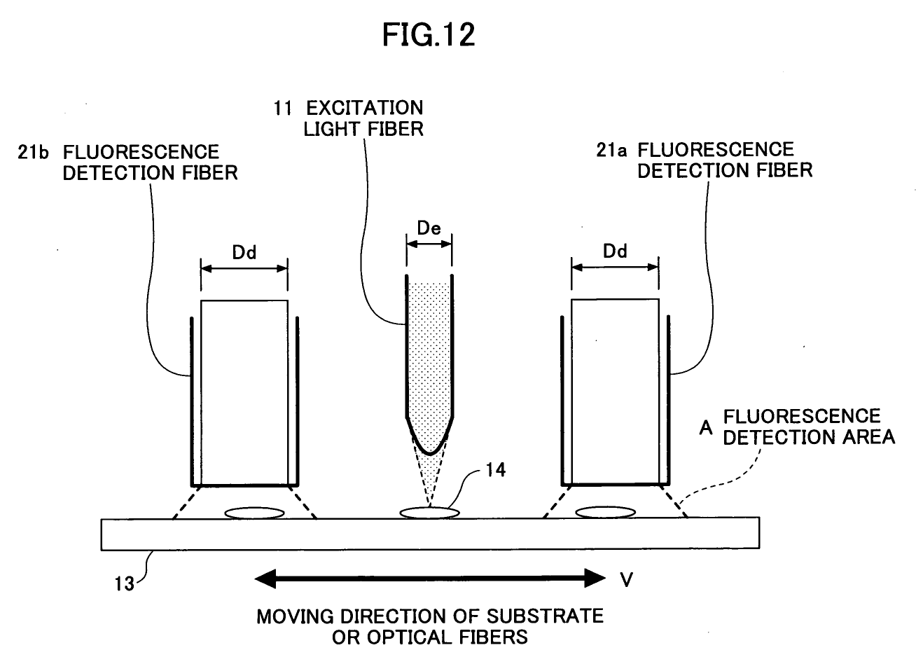

FIG. 12 is a diagram showing a basic configuration of a fluorescence detecting apparatus according to a fifth embodiment of the present invention. According to the fifth embodiment, fluorescence detection fibers 21a and 21b are arranged on left and right sides of the excitation light fiber 11. The optical fibers 11, 21a, and 21b are moved sideways relative to the position of the substrate 13 to detect fluorescent light. For example, the set of optical fibers 11, 21a, and 21b may initially be positioned so that the excitation light fiber 11 may be arranged on a long side center line of the substrate 13 having examining spots 14 arranged thereon, and the substrate 13 may be oscillated sideways (to the left and rights sides of FIG. 12) at an oscillation width of approximately 25 mm. When the substrate 13 is oscillated toward the right side of FIG. 12, the fluorescent light generated from the examining spot 14 located on the left side with respect to the center line is detected by the fluorescence detection fiber 21a located on the right side, and when the substrate 13 is oscillated toward the left side of FIG. 12, the fluorescent light generated from the examining spot 14 located on the right side with respect to the center line is detected by the fluorescence detection fiber 21b located on the left side. In other words, according to the present embodiment, when the substrate 13 moves to the right relative to the position of the optical fiber set, fluorescence is detected by the fluorescence detection fiber 21a, and when the substrate 13 moves to the left relative to the position of the optical fiber set, fluorescence is detected by the fluorescence detection fiber 21b. In this way, fluorescence may be detected from examining spots 14 arranged in a two-dimensional array in a shorter period of time. In one preferred embodiment, the excitation light fiber 11 and the fluorescence detection fibers 21a and 21b may be integrated into a head structure.

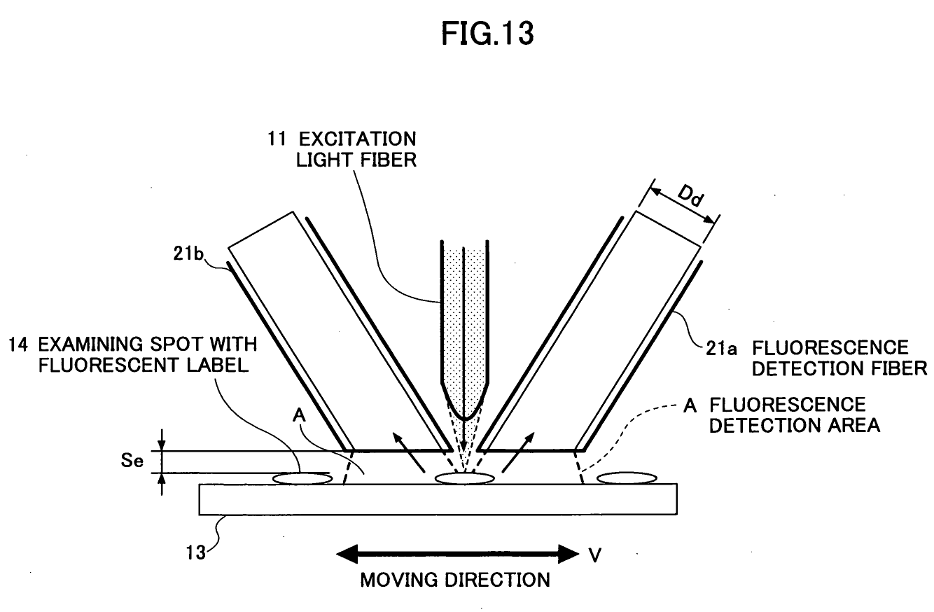

FIG. 13 is a diagram showing a basic configuration that incorporates the basic structure of FIG. 9 into that of FIG. 12. Specifically, in the illustrated configuration of FIG. 13, the edges of fluorescence detection fibers 21a and 21b on the left and right sides of the excitation light fiber 11 are arranged to be diagonal. In this configuration, although the distance between the optical fibers 11, 21a, and 21b have to be changed in order to change the detection delay time Td, by positioning the optical fibers 11, 21a, and 21b as is shown in FIG. 13, the fluorescence detection area A may be extended to cover the excitation light irradiation area of the excitation light fiber 11 so that both time-resolved fluorescence detection for detecting the fluorescence light of a sample using a label with delayed fluorescence and simultaneous fluorescence detection for detecting the fluorescent light of a sample using a label with little delayed fluorescence may be performed without having to change the distance between the optical fibers 11, 21a, and 21b.

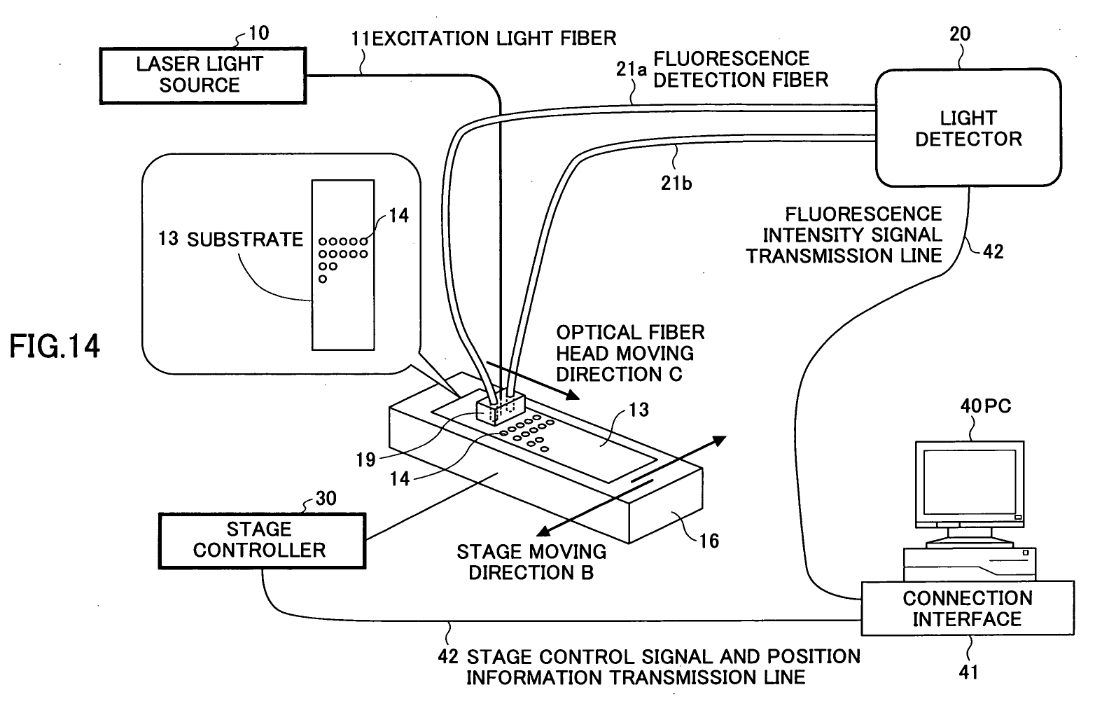

FIG. 14 is a diagram showing an exemplary overall configuration of a fluorescence detecting apparatus that incorporates the basic configuration shown in FIG. 13. In the illustrated example of FIG. 14, an oscillating stage 16 that moves back and forth in parallel directions is used instead of a rotating stage, and a substrate 13 having examining spots 14 is placed on the this oscillating stage 16. It is noted that component elements shown in this drawing that are identical to those shown in FIG. 6 are given the same reference numerals and their descriptions may be omitted. The oscillating stage 16 is oscillated sideways at an oscillation width of approximately 25 mm. The oscillating directions correspond to stage moving directions B in the present example. Also, the end portions of the excitation light fiber 11 and the fluorescence detection fibers 21a and 21b are held together to form an optical fiber head 19, which is slowly moved in a fiber head moving direction C that is perpendicular to the stage moving directions B. The detector 20 measures the fluorescence intensity of fluorescent light according to the position of the excitation light fiber 11. The PC 40 forms an image based on the detection data obtained by the detector 20. Also, it is noted that the examining spots 14 are arranged into a matrix on the substrate 13.

In one preferred embodiment, different types of optical fiber heads 19 may be prepared beforehand, and the optical fiber head 19 to be used may be selected according to the type of fluorescent label used in the sample to be examined. For example, one optical fiber head 19 adapted for the configuration of FIG. 12 in which the distance between the optical fibers 11, 21a, and 21b is set to Lf=V*Td (where V denotes the oscillation speed and Td denotes the detection delay time) may be used for delayed detection (i.e., time-resolved fluorescence detection), and another optical fiber head 19 that is adapted for the configuration of FIG. 13 in which the distance Lf is substantially close to zero may be used for simultaneous fluorescence detection.

In another preferred embodiment, the examining spot density may be arranged such that the sum of the spot diameter Ls of the examining spot 14 and the examining spot space interval Ss (see FIG. 5) is approximately equal to the diameter of the fluorescence detection area A. In this way, the examining spots 14 may be arranged at a relatively high density without causing significant problems. It is noted that problems may not arise as long as the sum (Ls+Ss) is greater than the diameter of the fluorescence detection area A; however, the examining spots 14 are preferably arranged at a high density in order to realize overall miniaturization and/or detection efficiency of the fluorescence detection apparatus, for example.

It is noted that the laser light source 10 of the apparatus of FIG. 14 may be a continuous wave (CW) laser as in the apparatus of FIG. 6; that is, the laser from the laser light source 10 does not have to be pulsed. Also, the detector 20 does not necessarily have to include a detection time control mechanism/function, and may be configured to continually detect fluorescent light and transmit the detection result to the PC 40 as an electrical signal. However, it is noted that a synchronization signal for establishing one to one correspondence between position information and fluorescence intensity information has to be generated from the oscillating stage 16 or the detector 20. Also, since the PC 40 is configured to process a digital signal, A/D conversion may be performed at the connection interface 41 for the PC 40.

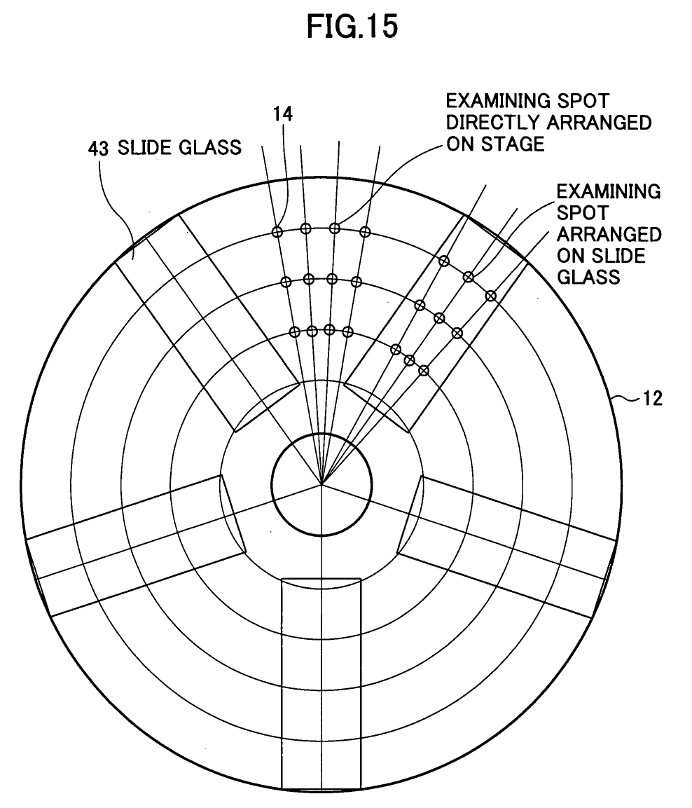

FIG. 15 is a diagram illustrating an exemplary arrangement of examining spots 14 in the case of using the rotating stage 12 as is shown in FIG. 6. In the present example, the examining spots 14 are preferably arranged in concentric circles and aligned in radial directions. In one embodiment, the examining spots 14 may be placed directly on the rotating stage 12 that may be made of quartz, for example. In another embodiment, the examining spots 14 may be arranged on a slide glass 43 and such a slide glass may be fixed to the rotating stage 12. In the case of using the slide glass 43, the examining spots 14 are preferably arranged on plural slides 43 in a manner such that they are aligned in radial directions and arranged in concentric circles upon being fixed to the rotating stage 12.

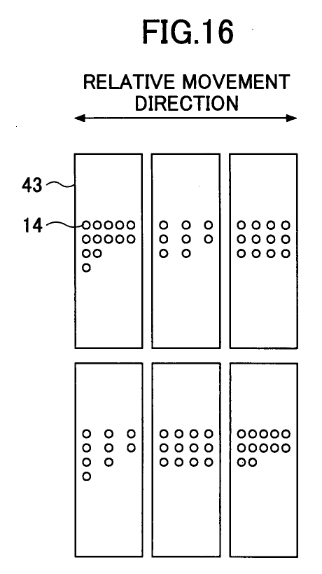

FIG. 16 is a diagram showing another exemplary arrangement of the examining spots 14 in the case where the oscillating stage 16 as is shown in FIG. 14 is used. In the illustrated example, plural glass slides 43 are arranged on the stage (not shown in FIG. 16), and examining spots 14 are arranged into a matrix on each of the glass slides 43. In one embodiment, the arrangement of the examining spots 14 on one glass slide 43 may be different from that of another glass slide 43. Specifically, different glass slides 43 may be have examining spots 14 in different spot sizes arranged at different spot intervals, for example. Fluorescence detection may be enabled on such an examining spot arrangement owing to the fact that while the stage is moving sideways (left to right) relative to the excitation light fiber 11 and the fluorescence detection fiber 21 (21a, 21b) or the optical fiber head 19, the fluorescence detection fiber 21 can detect fluorescent light after the elapse of a predetermined time Td from excitation light irradiation by the excitation light fiber 11 regardless of the size or spacing interval of the examining spots 14. It is noted that in this case, the examining spots 14 subject to detection have to be aligned along the oscillation directions.

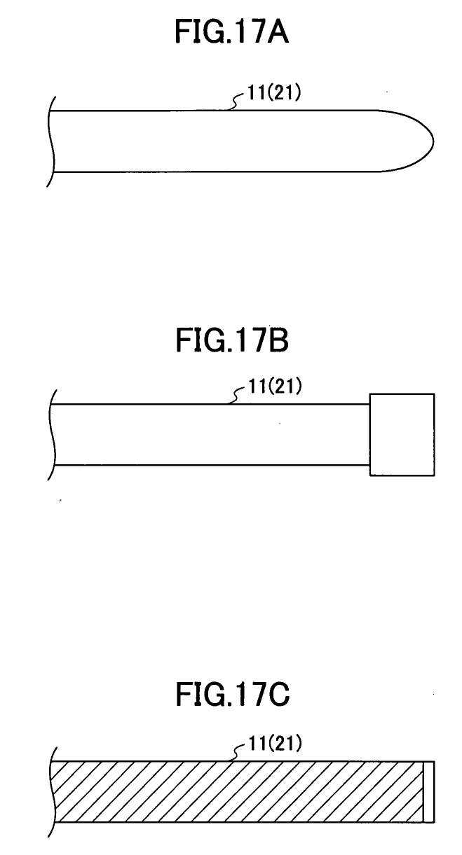

FIGS. 17A-17C are diagrams showing exemplary configurations of the end portions of the optical fibers. It is noted that the end portion configuration of the excitation light fiber 11 may affect the focusing of excitation light and formation of the excitation light irradiation area. The end portion configuration of the fluorescence detection fiber 21 may affect the formation of the fluorescence detection area.

FIG. 17A illustrates a case in which the end portion of an optical fiber as the excitation light fiber 11 or the fluorescence detection fiber 21 is arranged into a spherical surface or a tapered spherical surface. FIG. 17B illustrates a case in which a micro lens, an aspheric lens, or a rod lens is attached to the end portion of an optical fiber. FIG. 17C illustrates a case in which the end portion surface of the optical fiber strand is covered by a metal coating. In this case, the tip of the optical fiber may not be covered by the metal coating and be exposed, or alternatively, the end portion of the metal coating may extend further than the tip of the optical fiber so that the tip of the optical fiber may be set inward with respect to the peripheral edge of the metal coating. Further, the optical fiber edge surface may be arranged into concave surface or a convex surface.

As can be appreciated from the above descriptions, in a fluorescence detecting apparatus according to an embodiment of the present invention, detection operations may be switched from time-resolved detection mode to simultaneous detection mode and vice versa by merely adjusting the positional relationship between the excitation light fiber 11 and the fluorescence detection fiber 21. In this way, the fluorescence detecting apparatus may be adapted for detecting both a sample using a label with delayed fluorescence and a sample using a label with little or substantially no delayed fluorescence.

In one preferred embodiment, in the case of performing delayed fluorescent light detection (time-resolved fluorescence detection), the detection delay time Td corresponding to the time for background fluorescent light to disappear so as to start fluorescence detection may be continually changed to determine an optimal value for such detection delay time Td.

In the first embodiment of the present invention as is shown in FIG. 5, the position adjustment of the optical fibers with respect to the examining spots labeled with fluorescent labels and adjustment of the distance between the optical fibers Lf may be facilitated, for example.

In one preferred embodiment, He—Ne laser (visible light with a wavelength of 633 nm) may be used in the case of adjusting the positioning of the excitation light fiber and the fluorescence detection fiber, and He—Cd laser (with a wavelength of 325 nm) as CW laser light may be incident to the excitation light fiber 11 in the case of performing actual detection of fluorescence light.

It is noted that in the above-described preferred embodiments of the present invention, the rotating stage 12, the oscillating stage 16, and/or the optical fiber head 19 are used to move the examining spots 14 relative to the positions of the excitation light fiber 11 and the fluorescence detection fiber 21. However, the present invention is not limited to such embodiments, and other mechanisms such as a conveyor belt may equally be used to move the examining spots 14 relative to the positions of the excitation light fiber 11 and the fluorescence detection fiber 21.

Although the present invention is shown and described with respect to embodiments, it is obvious that equivalents and modifications will occur to others skilled in the art upon reading and understanding the specification. The present invention includes all such equivalents and modifications, and is limited only by the scope of the claims.

The present application is based on and claims the benefit of the earlier filing date of Japanese Patent Application No. 2006-308319 filed on Nov. 14, 2006, the entire contents of which are hereby incorporated by reference.

What is claimed is:

1. A fluorescence detecting apparatus comprising:
a substrate on which an examining spot including a sample labeled with a fluorescent label is arranged;
an excitation light irradiating optical fiber configured to irradiate excitation light on the examining spot;
a fluorescence detecting optical fiber configured to detect fluorescent light generated from the examining spot; and
a moving mechanism configured to cause relative movement of the examining spot from the excitation light irradiating optical fiber side to the fluorescence detecting optical fiber side.

2. The fluorescence detecting apparatus as claimed in claim 1, wherein
the excitation light irradiating optical fiber and the fluorescence detecting optical fiber are positioned on opposite sides of the substrate.

3. The fluorescence detecting apparatus as claimed in claim 1, wherein
the excitation light irradiating optical fiber and the fluorescence detecting optical fiber are positioned on a same side of the substrate.

4. The fluorescence detecting apparatus as claimed in claim 1, wherein
a distance between the excitation light irradiating optical fiber and the examining spot is arranged to be within a range of 50 μm to 1 mm.

5. The fluorescence detecting apparatus as claimed in claim 1, wherein
an edge of the fluorescence detecting optical fiber is arranged to be diagonal with respect to an extending direction of the fluorescence detecting optical fiber.

6. The fluorescence detecting apparatus as claimed in claim 1, further comprising at least one of:
an optical element configured to redirect light irradiated from the excitation light irradiating optical fiber and transmitted through the examining spot back to the examining spot; and
an optical element configured to condense the fluorescent light generated from the examining spot onto the fluorescence detecting optical fiber.

7. The fluorescence detecting apparatus as claimed in claim 1, wherein
a position of the fluorescence detecting optical fiber is adjustable with respect to a position of the excitation light irradiating fiber.

8. The fluorescence detecting apparatus as claimed in claim 1, wherein
an edge of the fluorescence detecting optical fiber is arranged such that a fluorescence detection area of the fluorescence detecting optical fiber covers an excitation light irradiation spot of the excitation light irradiating optical fiber; and
a relative positioning of the excitation light irradiating optical fiber and the fluorescence detecting optical fiber is fixed.

9. The fluorescence detecting apparatus as claimed in claim 1, wherein
the fluorescence detecting optical fiber comprises a pair of fluorescence detecting optical fibers;
the excitation light irradiating optical fiber is arranged between the fluorescence detecting optical fibers; and
the substrate with the examining spot is configured to move in two directions with respect to the excitation light irradiating optical fiber and the pairs of fluorescence detecting optical fibers.

10. The fluorescence detecting apparatus as claimed in claim 9, further comprising:
an optical fiber head that combines the excitation light irradiating optical fiber and the pair of fluorescence detecting optical fibers.

11. The fluorescence detecting apparatus as claimed in claim 1, wherein
a positioning of the fluorescence detecting optical fiber with respect to the excitation light irradiating optical fiber is adjusted such that in a case where the fluorescent label of the sample generates delayed fluorescent light, a condition
Lf=V*Td
is satisfied, where Lf denotes a distance between the fluorescence detecting optical fiber and the excitation light irradiating optical fiber, Td denotes a time required for background fluorescent light to disappear after being generated from a portion of the examining spot other than the label in response to irradiation of the excitation light, and V denotes a relative moving speed of the examining spot with respect to the fluorescence detecting optical fiber and the excitation light irradiating optical fiber.

12. The fluorescence detecting apparatus as claimed in claim 1, wherein
a positioning of the fluorescence detecting optical fiber with respect to the excitation light irradiating optical fiber is adjusted such that in a case where the fluorescent label of the sample generates substantially no delayed fluorescent light, a condition
0≦Lf≦R1+R2
is satisfied, where Lf denotes a distance between the fluorescence detecting optical fiber and the excitation light irradiating optical fiber, R1 denotes a radius of the excitation light irradiating optical fiber, and R2 denotes a radius of the fluorescence detecting optical fiber.

13. The fluorescence detecting apparatus as claimed in claim 1, wherein
the moving mechanism is a rotating stage that is configured to rotate holding the substrate.

14. The fluorescence detecting apparatus as claimed in claim 1, wherein
the moving mechanism is an oscillating stage that is configured to oscillate back and forth holding the substrate.

15. The fluorescence detecting apparatus as claimed in claim 1, further comprising:
a continuous wave light source that is connected to the excitation light irradiating optical fiber.

16. The fluorescence detecting apparatus as claimed in claim 1, further comprising:
an information processing unit that gathers and processes information on the fluorescent light detected by the fluorescence detecting optical fiber.

17. A fluorescence detecting method comprising the steps of:
exciting an examining spot including a sample that is labeled with a fluorescent label using an excitation light irradiating optical fiber; and
detecting fluorescent light generated from the fluorescent label in response to the excitation using a fluorescence detecting optical fiber after background fluorescent light generated from a portion of the sample other than the fluorescent label disappears.

18. The fluorescence detecting method as claimed in claim 17, further comprising a step of:
arranging a distance between a detection area of the excitation light irradiating optical fiber and the examining spot to be within a range of 50 μm to 1 mm.
